(19) United States
(12) Patent Application Publication
(10) Pub. No.: US 2011/0035361 A1
(43) Pub. Date: Feb. 10, 2011

(54) RESTORATION CONTROL APPARATUS AND METHOD THEREOF

(75) Inventor: Katsuyoshi SOGA, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/845,877

(22) Filed: Jul. 29, 2010

(30) Foreign Application Priority Data
Aug. 6, 2009 (JP) 2009-183538

(51) Int. Cl. G06F 17/30

(52) U.S. Cl. 707/675; 707/E17.005

(57) ABSTRACT

A restoration control apparatus for restoring a status of data arrangement on a destination storage device to a status of data arrangement on a source storage device before backup. The restoration control apparatus includes a determiner and a controller. The determiner determines whether a first storage area, where the backed up data is to be restored, on the destination storage device preserves prior data. Upon determining by the determiner that the first storage area does not preserve prior data, the controller stores the backed up data in the first storage area. Upon determining by the determiner that the first storage area preserves the prior data, the controller stores the backed up data in an unused second storage area on the destination storage device or copies the prior data preserved in the first storage area to the second storage area to store the backed up data in the first storage area.

### CROSS-REFERENCE TO RELATED APPLICATION

This application is based upon and claims the benefit of priority of the prior Japanese Patent Application No. 2009-183538, filed on Aug. 6, 2009, the entire contents of which are incorporated herein by reference.

### FIELD

The embodiments discussed herein are related to a restoration control technique.

### BACKGROUND

Known as a disk data backup function is an image backup function for backing up data only on sectors used in a file system. When the data backed up by the image backup function is restored to a disk, the backed up data is written back to the disk.

When the data backed up by the image backup function is restored to the disk, the data is typically written as is at the same location as the location where the backed up data had been stored before the backup, in the same order as the order at the backup. A file system present on the disk prior to restoration is overwritten by the restoration.

FIG. 1 illustrates an example of data backup and restoration. In the example of FIG. 1, data on a disk 10 is restored to a disk 30.

As illustrated in FIG. 1, the disk 10 stores data_1 to data_5. The disk 10 has unused areas having no data stored thereon. The data_1 to data_5 on the disk 10 are restored as backup image files to a disk 20 in the backup by the image backup function. The unused areas of the disk 10 are not restored. When the backup image files on the disk 20 is restored on the disk 30, the data_1 to data_5 are written to the disk 30 at the same locations as those in the disk 10 before the backup. The data that has been stored on the disk 30 prior to the restoration is overwritten by the restoration. Thereafter, a behavior check is performed to check whether the file system on the restoration destination disk runs, and the like.

Japanese Laid-open Patent Publication No. 11-15604 and Japanese Laid-open Patent Publication No. 6-60075 disclose related techniques.

### SUMMARY

According to an aspect of the present invention, provided is a restoration control apparatus for restoring, in accordance with backup information including backed up data, a status of data arrangement on a destination storage device to a backup state representing a status of data arrangement on a source storage device before the backed up data has been backed up. The restoration control apparatus includes a determiner and a controller.

The determiner determines, during restoration, whether a first storage area on the destination storage device preserves prior data. The first storage area is a storage area where the backed up data is to be restored.

Upon determining by the determiner that the first storage area does not preserve prior data, the controller stores the backed up data in the first storage area.

Upon determining by the determiner that the first storage area preserves the prior data, the controller stores the backed up data in an unused second storage area on the destination storage device. Alternatively, the controller copies the prior data preserved in the first storage area to the second storage area to store the backed up data in the first storage area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of data backup and restoration.

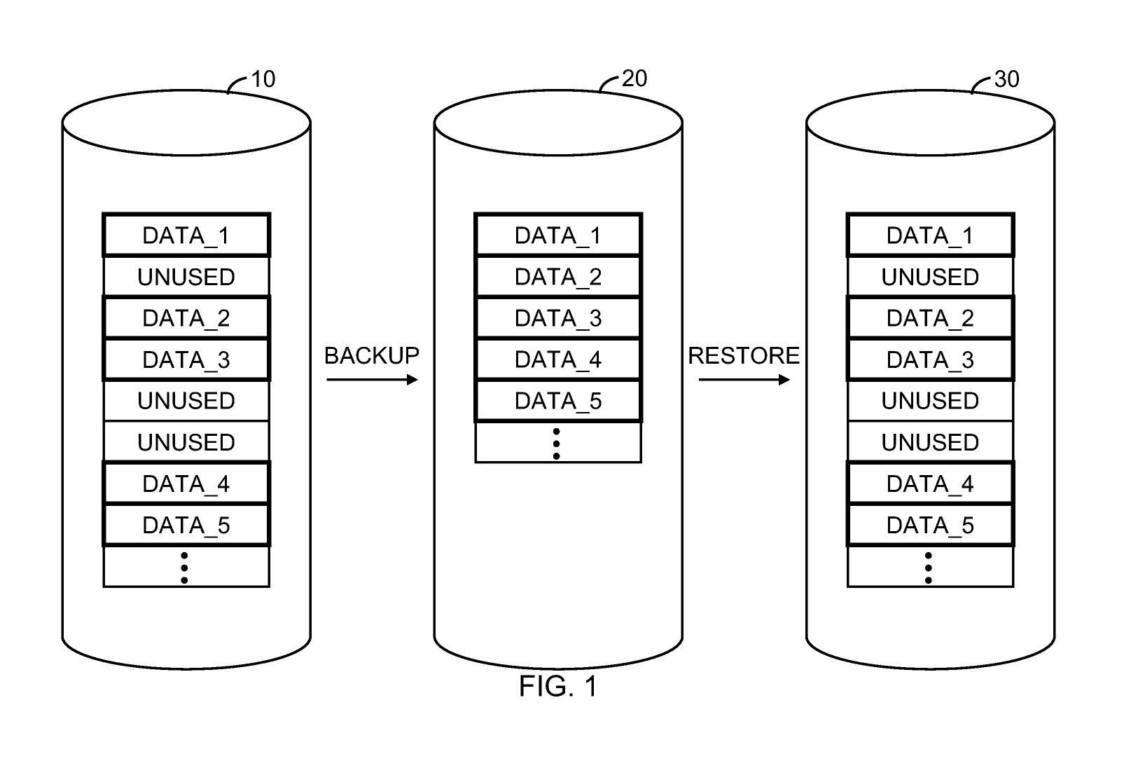

FIG. 2 is a diagram illustrating an example of a system configuration of a restoration control apparatus according to an embodiment of the present invention;

FIG. 3 is a diagram illustrating an example of a system configuration of a restoration control apparatus according to an embodiment of the present invention;

FIG. 4 is a diagram illustrating an example of data arrangement of a backup source storage device;

FIG. 5 is a diagram illustrating an example of an operation flow of a restoration control apparatus according to an embodiment of the present invention;

FIG. 6 is a diagram illustrating an example of an operation flow of a restoration control apparatus according to an embodiment of the present invention;

FIG. 7 is a diagram illustrating an example of an operation flow of a restoration control apparatus according to an embodiment of the present invention;

FIG. 8 is a diagram illustrating an example of an operation flow of a restoration control apparatus according to an embodiment of the present invention;

FIG. 9 is a diagram illustrating an example of an operation flow of a restoration control apparatus according to an embodiment of the present invention;

FIG. 10 is a diagram illustrating an example of a usage status of a storage device before restoration;

FIG. 11 is a diagram illustrating an example of data arrangement of a restoration destination storage device before restoration;

FIG. 12 is a diagram illustrating an example of a usage status data table stored on a primary memory according to an embodiment of the present invention;

FIG. 13 is a diagram illustrating an example of a second management information table included in file system management information according to an embodiment of the present invention;

FIG. 14 is a diagram illustrating an example of a second management information table included in file system management information according to an embodiment of the present invention;

FIG. 15 is a diagram illustrating an example of a second management information table included in file system management information according to an embodiment of the present invention;

FIG. 16 is a diagram illustrating an example of a second management information table stored in a storage device according to an embodiment of the present invention;

FIG. 17 is a diagram illustrating an example of a usage status of a storage device according to an embodiment of the present invention;

FIG. 18 is a diagram illustrating an example of data arrangement of a storage device according to an embodiment of the present invention; and

FIG. 19 is a diagram illustrating an example of a system configuration of a computer system.

### DESCRIPTION OF EMBODIMENTS

In the restoration according to the above-discussed conventional technique, data that has been stored on the restoration destination disk prior to the restoration is overwritten by the restoration. If the restoration is aborted, it may be difficult to restore the data, which has been stored on the restoration destination disk prior to the restoration, to the status before the restoration. The file system present on the restoration destination disk prior to the restoration is overwritten by the restoration. Even if any problem is detected in the behavior check, it may be also difficult to restore the file system, which has been present on the restoration destination disk prior to the restoration, to the status before the restoration.

It may be preferable to perform a restoration while maintaining data on a restoration destination storage device.

Embodiments of the present invention will be discussed with reference to the drawings. The configuration of each embodiment is discussed for exemplary purposes only, and the embodiments are not limited to those disclosed herein.

### First Embodiment

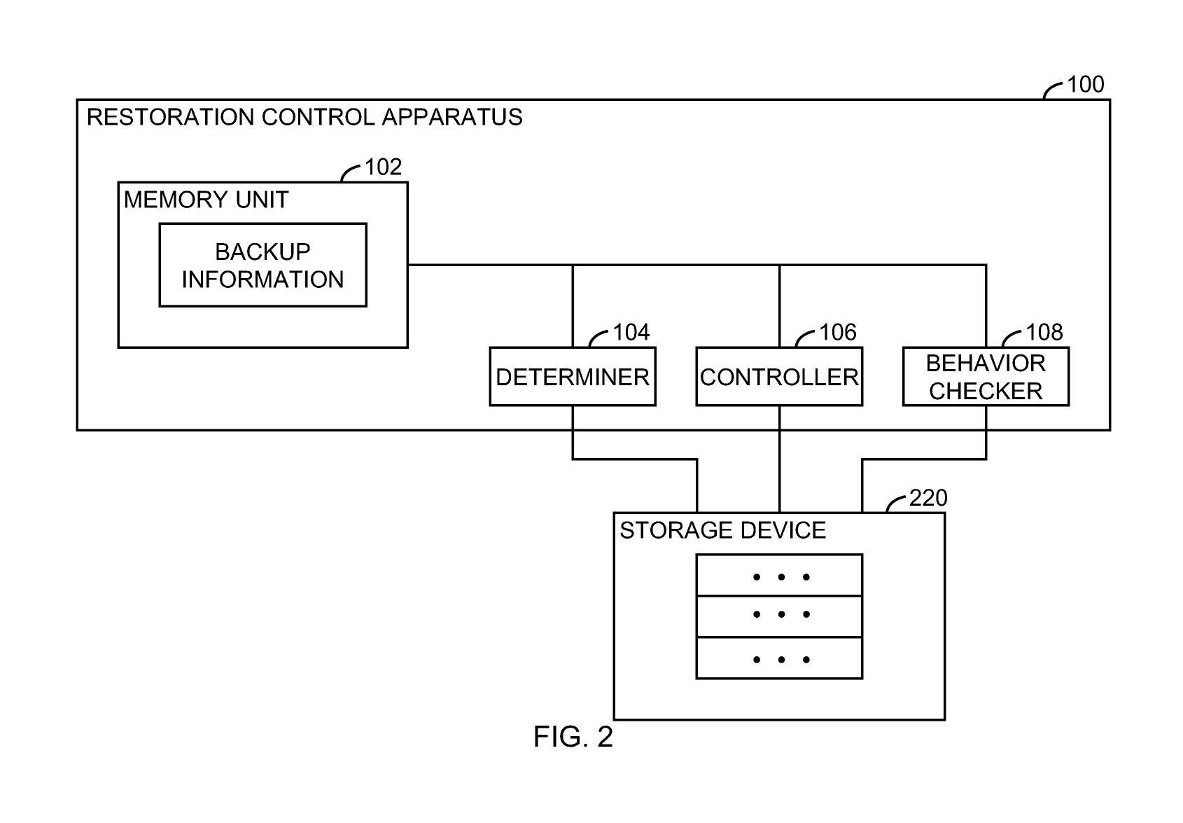

FIG. 2 illustrates an example of a system configuration of a restoration control apparatus 100 according to the present embodiment. The restoration control apparatus 100 performs a data restoration to reconstruct a status of data arrangement on a storage device 220 to a backup state in accordance with backup information. The backup state refers to a status of data arrangement on a backup source storage device before the backup.

The restoration control apparatus 100 includes a memory unit 102, a determiner 104 and a controller 106. The restoration control apparatus 100 may also include a behavior checker 108. The restoration control apparatus 100 is connected to the storage device 220.

The memory unit 102 stores backup information. The backup information to be stored in the memory unit 102 is retrieved from an external storage device (backup source storage device). The external storage device may be the storage device 220 or a storage device other than the storage device 220. The backup information is used to reconstruct the status of data arrangement on the storage device 220 to the status of data arrangement on the external storage device before the backup. The backup information includes backed up data, data on a restoration location of the backed up data, etc.

The memory unit 102 may store location data of another storage area where the backup information is stored. The memory unit 102 may store location data of a storage area storing the backup information and location data of another storage area storing other data. The memory unit 102 may store location data of the backup information and the other data within the storage device.

The determiner 104 determines, during the restoration, whether a storage area (referred to as a destination area) of the storage device 220, which corresponds to the restoration location of the backed up data, preserves other data (referred to as prior data).

The controller 106 stores the backed up data in the destination area when the determiner 104 has determined that the destination area on the storage device 220 does not preserve prior data. Location data of the destination area, i.e., location data of the backed up data, may be stored in the memory unit 102.

When the determiner 104 has determined that the destination area on the storage device 220 preserves the prior data, the controller 106 stores the backed up data in another unused storage area on the storage device 220. Location data of the other storage area, i.e., location data of the backed up data, may be stored in the memory unit 102. Alternatively, the controller 106 may copy the prior data to another unused storage area on the storage device 220 and store the backed up data in the destination area. The other storage area may be on another storage device. The location data of the destination area and the location data of the other storage area, i.e., the location data of the backed up data and the location data of the prior data, may be stored in the memory unit 102.

The controller 106 may store the backed up data in the other unused storage area when the destination area preserves the prior data and when change of the restoration location of the backed up data is permitted. Upon receiving an instruction to abort the restoration during the restoration, the controller 106 may delete the backed up data stored in the other storage area in accordance with location data of the other storage area. The controller 106 may copy the prior data to the other storage area to store the backed up data in the destination area when the destination area preserves the prior data and when change of the restoration location of the backed up data is inhibited. Upon receiving an instruction to abort the restoration during the restoration, the controller 106 may copy the prior data back to the destination area while deleting the prior data from the other storage area, in accordance with the location data of the other storage area and the location data of the destination area.

The behavior checker 108 performs a behavior check, that is, the behavior checker 108 checks behavior of the storage device 220 in the backup state by using the backed up data stored in the storage device 220. When the behavior check of the storage device 220 in the backup state indicates an abnormality, the controller 106 reverts the status of data arrangement on the storage device 220 to a status before the restoration in accordance with the location data of the backed up data and the location data of the prior data on the storage device 220.

The restoration control apparatus 100 may be a general-purpose computer such as a personal computer (PC) or a dedicated computer such as a server machine. Also, the restoration control apparatus 100 may be a general-purpose computer, a dedicated computer, or an electronic apparatus including the computer, such as a personal computer, a workstation, and a personal digital assistant (PDA).

The computer, i.e., an information processing apparatus includes a processor, a main memory, a secondary memory, and an interface device, such as a communication interface, interfacing with a peripheral device. The main memory and the secondary memory are computer-readable storage media. The computer-readable storage media may be any computer-readable media except for a transitory, propagating signal.

The processor loads a program stored in the storage medium onto a work area on the main memory, executes the program, and controls the peripheral devices by executing the program. The computer thus performs a function satisfying a specific purpose.

The processor may include a central processing unit (CPU), or a data signal processor (DSP). The main memory may include a random-access memory (RAM), or a read-only memory (ROM).

The secondary memory may include an erasable programmable ROM (EPROM), or a hard disk drive (HDD). The secondary memory may be a removable medium i.e., a portable recording medium. The removable media may include a universal serial bus (USB) memory, and a disk memory such as a compact disk (CD), or a digital versatile disk (DVD).

The communication interface device may include a local-area network (LAN) interface board and a wireless communication circuit for wireless communication.

In addition to the secondary memory and the communication interface device, the peripheral devices may include input devices such as a keyboard and a pointing device, and output devices, such as a display and a printer. The input devices may also include a video and image input device such as a camera, or an audio input device such as a microphone. The output devices may also include an audio output device, such as a loudspeaker.

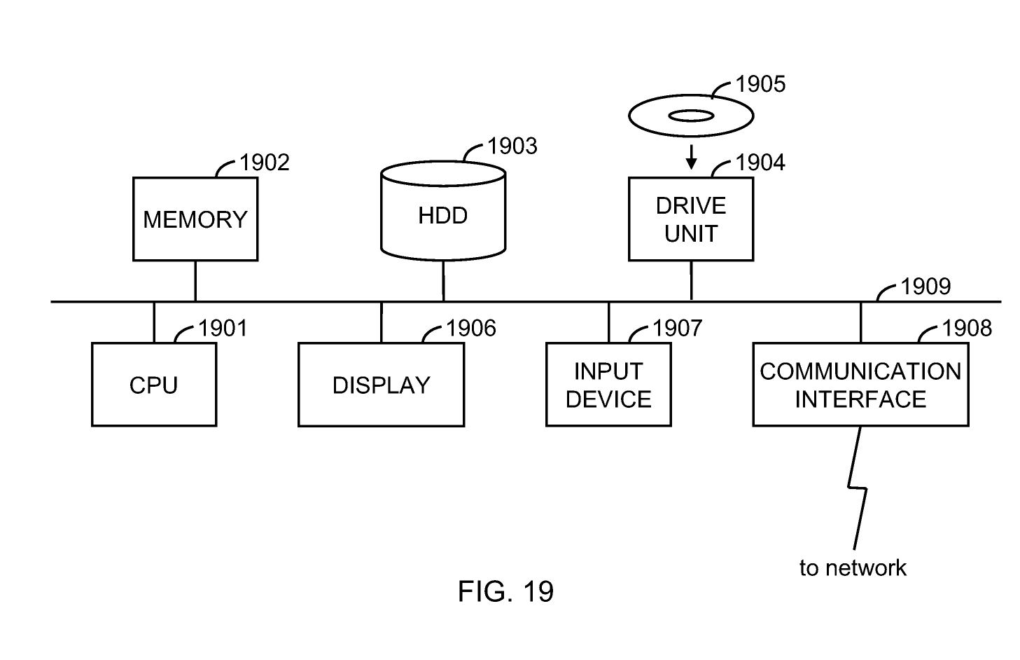

The computer as the restoration control apparatus 100 performs the functions of the determiner 104 and the controller 106 when the processor loads the program stored on the secondary memory to the main memory for execution. On the other hand, the memory unit 102 is arranged on a storage area on the main memory or of the secondary memory. FIG. 19 illustrates an example of a system configuration of a computer system. The example illustrated in FIG. 19 includes a CPU 1901, a memory 1902, an HDD 1903, a drive unit 1904 for driving a removable media 1905, a display 1906, an input device 1907, a communication interface 1908, and a bus 1909 for connecting these components.

The restoration control apparatus 100 according to the present embodiment restores the status of data arrangement on the storage device 220 to the backup state in accordance with the backup information.

During the restoration, the restoration control apparatus 100 may hold, on the storage device 220, the prior data that has been preserved on the storage device 220 before the restoration. The restoration control apparatus 100 may store the backed up data on the storage device 220 while maintaining the status of data arrangement of the prior data on the storage device 220. In response to an abortion of the restoration, the restoration control apparatus 100 may revert the status of data arrangement on the storage device 220 to the status before the restoration by deleting the backed up data.

The restoration control apparatus 100 may store the backed up data in a storage area corresponding to a restoration location while holding the prior data in another unused storage area on the storage device 220. In response to an abortion of the restoration, the restoration control apparatus 100 may revert the status of data arrangement on the storage device 220 to the status before the restoration by moving the prior data. In response to an abnormality detected in the behavior check, the restoration control apparatus 100 may revert the status of data arrangement on the storage device 220 to the status before the restoration.

### Second Embodiment

A second embodiment of the present invention will be discussed below. The second embodiment is similar in several arrangements to the first embodiment. Differences between the first and second embodiments will be discussed below, and the similar arrangements will not be discussed.

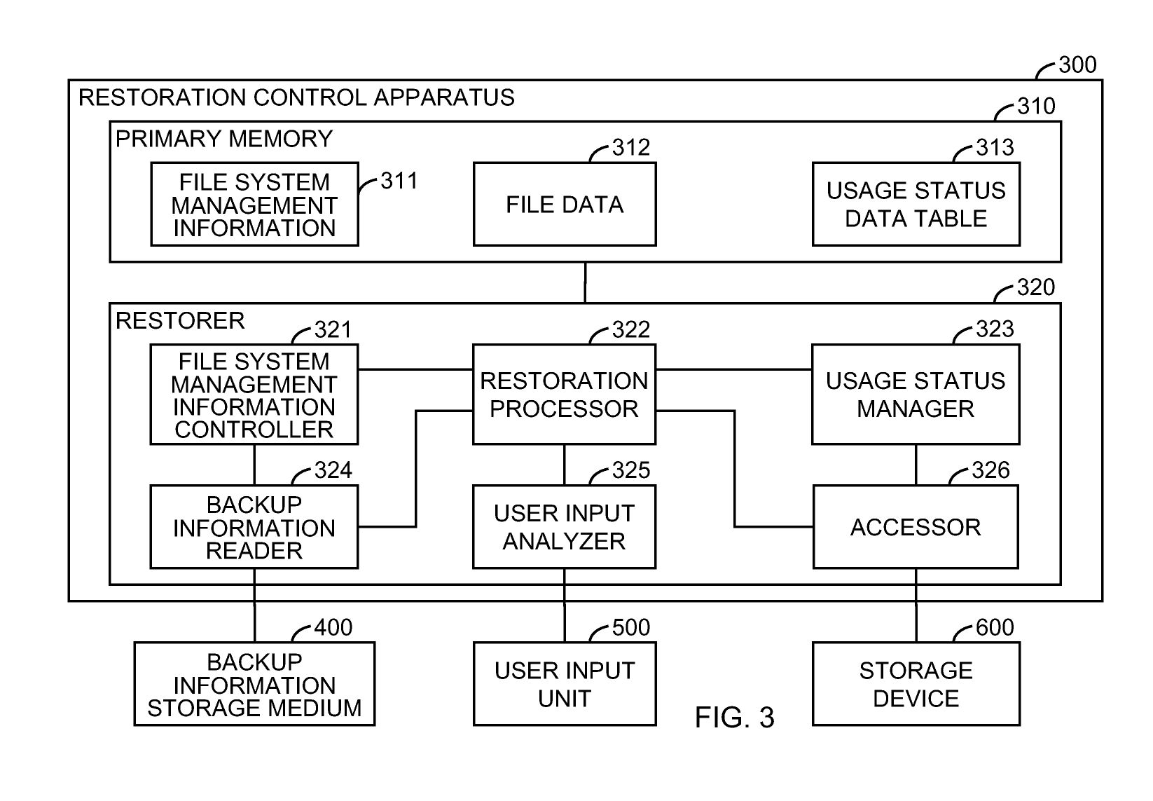

FIG. 3 illustrates an example of a system configuration of a restoration control apparatus 300 according to the present embodiment. The restoration control apparatus 300 restores backed up data stored in a backup information storage medium 400 to a storage device 600. The restoration control apparatus 300 includes a primary memory 310 and a restorer 320.

The restoration control apparatus 300 is connected to the backup information storage medium 400, a user input device 500, and the storage device 600.

The backup information storage medium 400 stores backup information including backed up data backed up from a backup source storage device. The backed up data includes a first management information table, a second management information table, and file data. The backup information also includes location data of the first management information table.

An information processing apparatus such as the restoration control apparatus 300 connected to a storage device such as the storage device 600 reads the second management information table in accordance with location data of the second management information table, which is included in the first management information table, to read desired file data. The information processing apparatus then reads the desired file data in accordance with location data of the file data, which is included in the second management information table. Thus, the information processing apparatus may have difficulty in reading the desired file data when the information processing apparatus has difficulty in reading the first management information table and the second management information table from the storage device.

The first management information table includes data of a location where the second management information table is stored. In the storage device, a location where the first management information table is stored is fixed. More specifically, change of the location where the first management information table is to be restored is inhibited in the restoration.

The second management information table includes data of a location where the file data is stored. In the storage device, the location where the second management information table is stored is variable. More specifically, change of the location where the second management information table is to be restored is permitted in the restoration.

The file data is managed in accordance with the second management information table stored in the storage device. According to the present embodiment, the location of the file data on the storage device may be variable. Change of the location where the file data is to be restored may be permitted in the restoration. When the location of the file data is fixed, the file data is handled in the same manner as the first management information table. It is noted that change of the location of the first management information table is inhibited.

The location of the first management information table, the location of the second management information table, and the location of the file data are specified by address on the storage device, for example. When the storage device is a hard disk drive, for example, a sector number may be used for the address on the storage device.

When the first management information table, the second management information table, and the file data of a backup source storage device are stored at an appropriate location on a restoration destination storage device in accordance with the backup information, the status of data arrangement on the backup source storage device is restored on the restoration destination storage device.

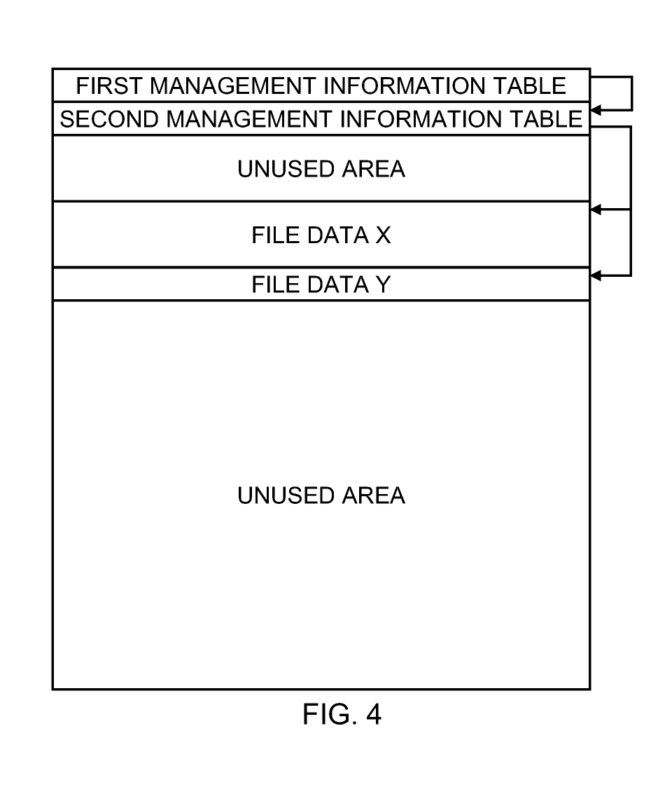

FIG. 4 illustrates an example of data arrangement of the backup source storage device. The backup source storage device illustrated in FIG. 4 stores the first management information table, the second management information table, file data X, and file data Y. The first management information table includes the location data of the second management information table. The second management information table includes location data of the file data X, and location data of the file data Y.

The first management information table, the second management information table, the file data, and the location data of the first management information table are retrieved from the backup source storage device to generate the backup information.

The user input device 500 receives an instruction or the like from a user. The user input device 500 may be an input device, such as a keyboard or a pointing device.

The storage device 600 is connected to the restoration control apparatus 300. The storage device 600 is an HDD, for example. The storage device 600 may have a plurality of storage areas. In accordance with the backup information, the status of data arrangement on the backup source storage device is restored on the storage device 600. The storage device 600 may preserve data before the restoration.

The primary memory 310 temporarily stores data to be used by the restorer 320. The primary memory 310 stores file system management information 311, file data 312, a usage status data table 313, and the like.

The file system management information 311 includes the first management information table, the second management information table, and the location data of the first management information table, read from the backup information. The file data 312 includes the file data read from the backup information storage medium 400. The usage status data table 313 includes data representing a usage status (used or unused) of storage areas on the storage device 600.

The restorer 320 reads the backup information from the backup information storage medium 400, and writes the backed up data to the storage device 600. The restorer 320 includes a file system management information controller 321, a restoration processor 322, a usage status manager 323, a backup information reader 324, a user input analyzer 325, and an accessor 326.

The file system management information controller 321 generates the file system management information 311 after the restoration in accordance with the backup information. The restoration processor 322 controls the entire restoration. The usage status manager 323 manages the usage status of the storage device 600. The backup information reader 324 reads data from the backup information storage medium 400. The user input analyzer 325 analyzes input data received from the user input device 500. The accessor 326 reads data from and writes data to the storage device 600.

The restoration control apparatus 300 may be a general-purpose computer such as a personal computer or a dedicated computer such as a server machine. Also, the restoration control apparatus 100 may be a general-purpose computer, a dedicated computer, or an electronic apparatus including the computer, such as a personal computer, a workstation, and a PDA.

The computer embodying the restoration control apparatus 300 performs a function of the restorer 320 when the processor loads a program stored in the secondary memory onto the main memory for execution. The primary memory 310 is implemented in a storage area on the main memory or the secondary memory.

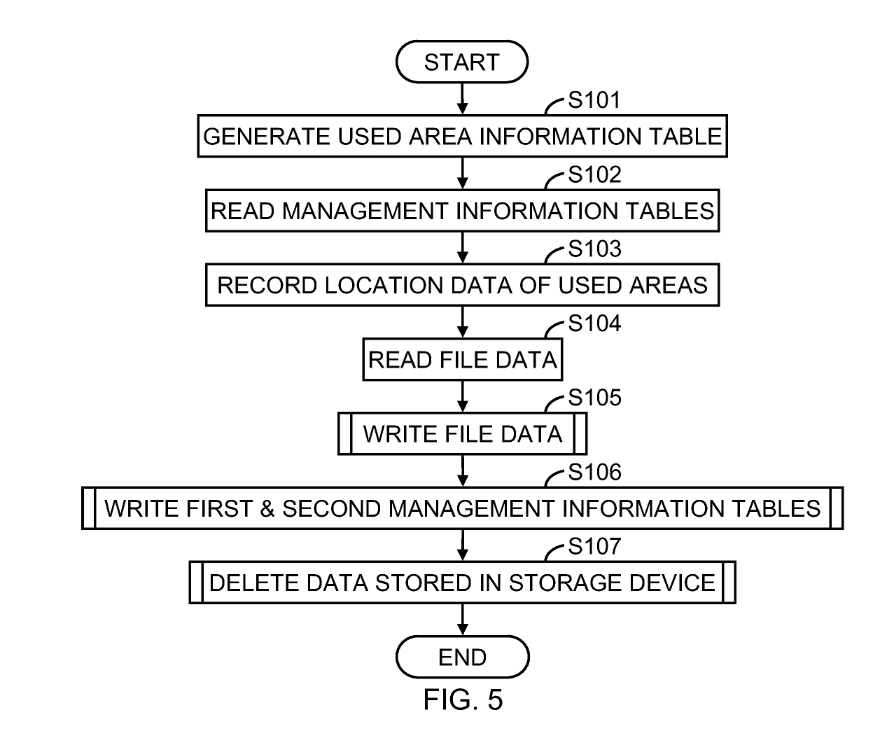

FIGS. 5-9 illustrate an example of an operation flow of the restoration control apparatus 300 according to the present embodiment. The restoration control apparatus 300 restores the status of data arrangement on the storage device 600 to a backup state in accordance with the backup information stored in the backup information storage medium 400.

In S101, upon receiving, via the user input device 500, a user instruction to the restoration control apparatus 300 for starting the restoration, the user input analyzer 325 of the restoration control apparatus 300 notifies the restoration processor 322 of the user instruction for starting the restoration.

The restoration processor 322 instructs the usage status manager 323 to check the usage status of the storage device 600. The usage status manager 323 instructs the accessor 326 to check the location of used areas and the location of unused areas on the storage device 600. The accessor 326 accesses the storage device 600 to detect the location of the used areas and the location of the unused areas. The accessor 326 notifies the usage status manager 323 of the detection results. The usage status manager 323 generates the usage status data table 313 including location data of the used areas and location data of the unused areas on the storage device 600 and stores the usage status data table 313 in the primary memory 310.

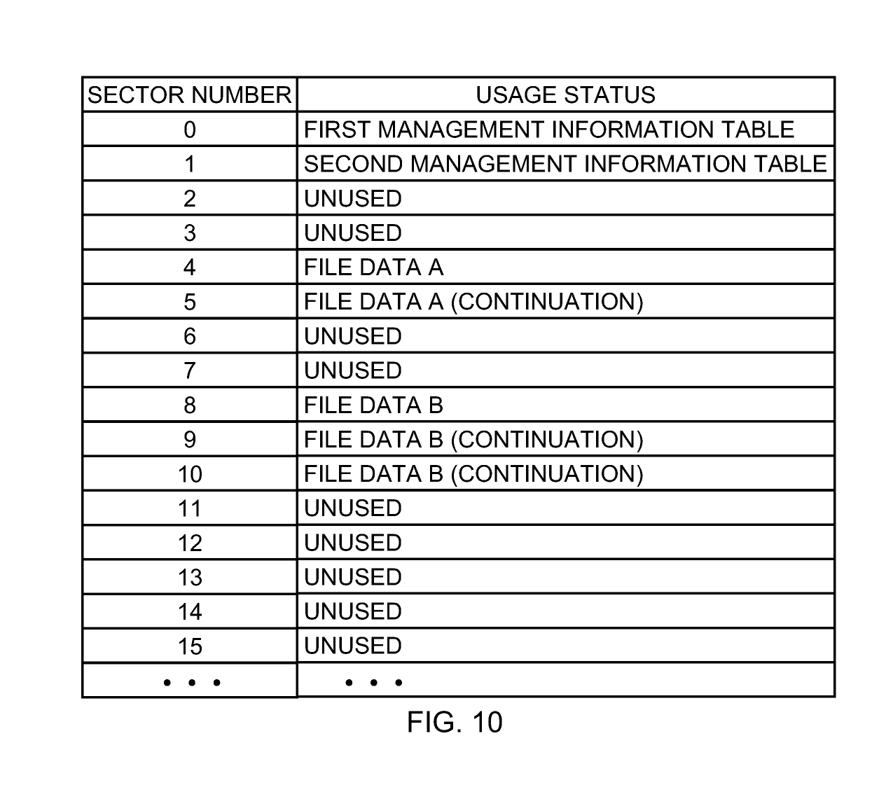

FIG. 10 illustrates an example of a usage status of the storage device 600 before the restoration. In the example illustrated in FIG. 10, the storage device 600 stores a first management information table, a second management information table, file data A, and file data B. The first management information table is stored in a sector with the sector number “0” on the storage device 600. The second management information table is stored in a sector with the sector number “1” on the storage device 600. The file data A is stored in sectors with the sector numbers “4” and “5” on the storage device 600. The file data B is stored in sectors with the sector numbers “8”, “9” and “10” on the storage device 600. The rest of sectors on the storage device 600 are unused areas.

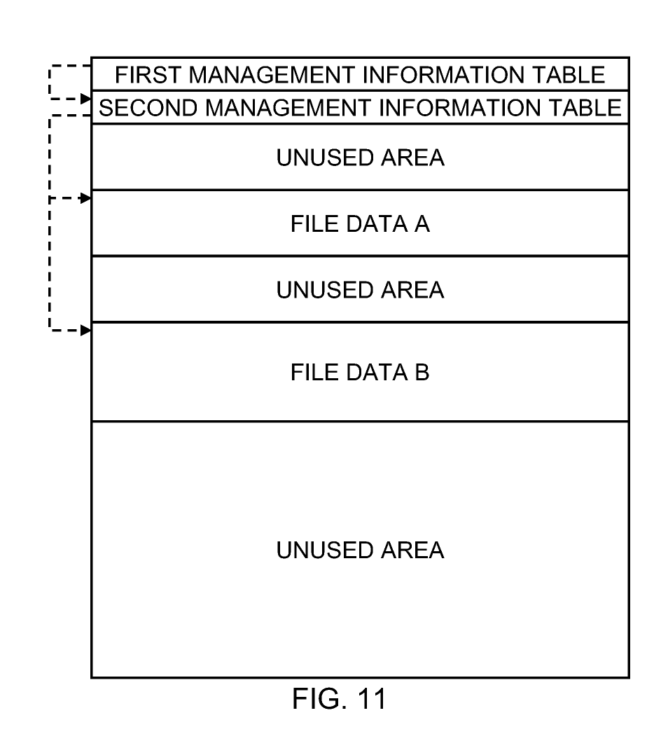

FIG. 11 illustrates an example of data arrangement of the storage device 600 before restoration. The first management information table includes the location data of the second management information table. The second management information table includes the location data of the file data A and the location data of the file data B.

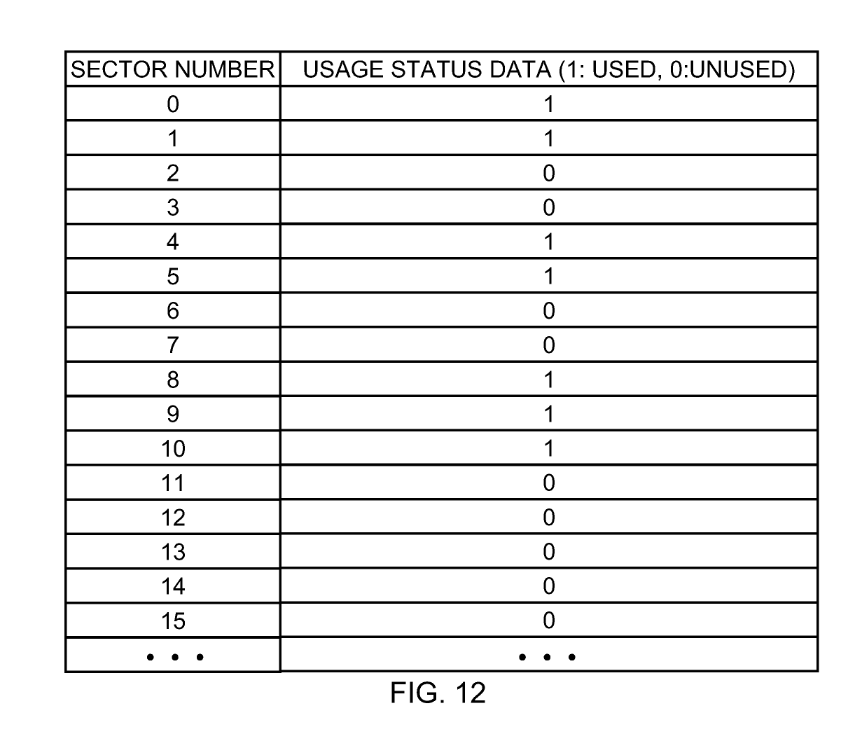

FIG. 12 illustrates an example of the usage status data table 313 stored on the primary memory 310 according to the present embodiment. The usage status data table 313 illustrated in FIG. 12 corresponds to the usage status of the storage device 600 illustrated in FIG. 10. As illustrated in FIG. 10, sectors with the sector numbers “0”, “1”, “4”, “5”, “8”, “9”, and “10” are used in the storage device 600. Thus, the usage status data table 313 stores “1” in association with these sector numbers to indicate that these sectors are used. The usage status data table 313 stores “0” in association with the sector numbers corresponding to unused sectors on the storage device 600.

In S102 of FIG. 5, the restoration processor 322 instructs the backup information reader 324 to read the backup information from the backup information storage medium 400. The backup information reader 324 reads the backup information from the backup information storage medium 400. The backup information reader 324 extracts the first management information table, the second management information table, and the location data of the first management information table from the backup information. The file system management information controller 321 stores the first management information table, the second management information table, and the location data of the first management information table, extracted by the backup information reader 324, in the primary memory 310 as the file system management information 311.

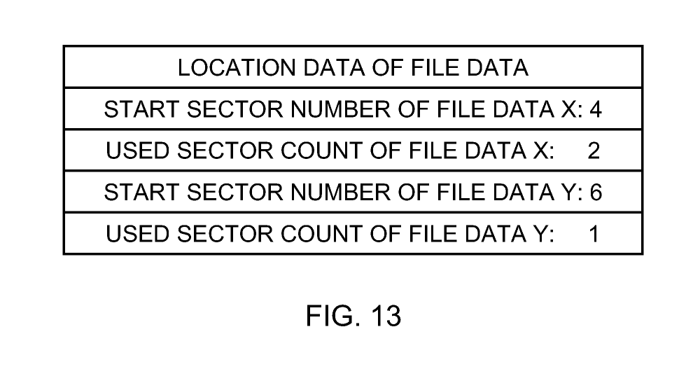

FIG. 13 illustrates an example of the second management information table included in the file system management information 311 according to the present embodiment. The second management information table includes the location data of the file data. The second management information table illustrated in FIG. 13 represents that the file data X uses two sectors from the sector with the sector number “4”. In other words, the file data X is stored in the sectors with the sector numbers “4” and “5”. The second management information table also represents that the file data Y uses one sector from the sector with the sector number “6”. In other words, the file data Y is stored in the sector with the sector number “6”. Although the storage location of the file data is specified by a start sector number and a sector count of used sectors in the example illustrated in FIG. 13, other methods may be used to specify the storage location of the file data.

In S103 of FIG. 5, the restoration processor 322 reads the usage status data table 313 indicating the usage status of the storage device 600 from the primary memory 310 via the usage status manager 323. The restoration processor 322 checks all the used areas on the storage device 600 in accordance with the usage status data table 313. The restoration processor 322 instructs the file system management information controller 321 to record all the used areas on the storage device 600 in the file system management information 311 as the storage locations of the file data. The file system management information controller 321 records all the used areas on the storage device 600 in the second management information table of the file system management information 311 stored in the primary memory 310.

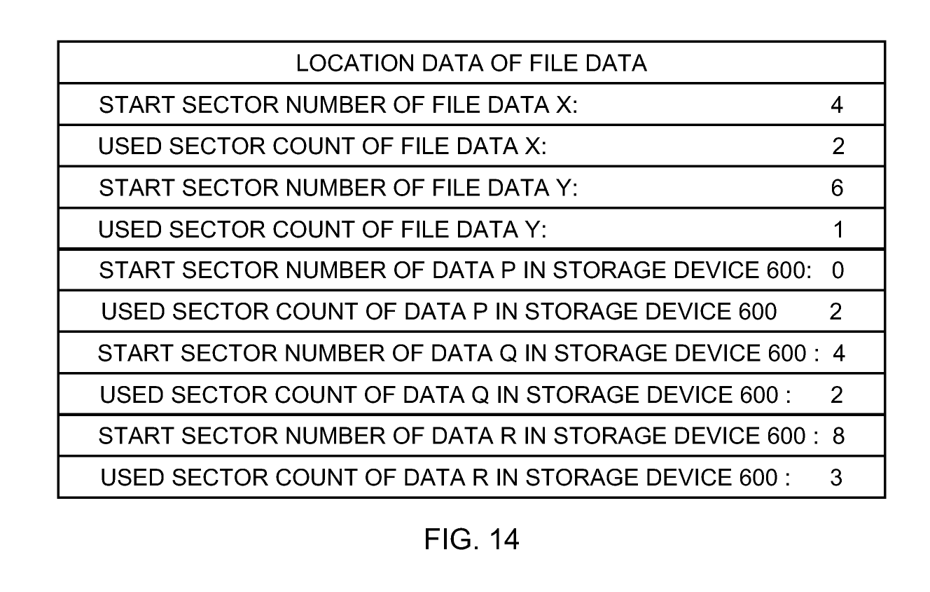

FIG. 14 illustrates an example of the second management information table included in file system management information 311 according to the present embodiment. The example in FIG. 14 illustrates the second management information table resulting after the location data of all the used areas on the storage device 600 has been recorded in S103. The second management information table illustrated in FIG. 14 stores the location data of data P, data Q, and data R in the storage device 600 that was data (the first management information table, the file data, etc.) stored in the storage device 600 before the restoration.

In S104 of FIG. 5, the backup information reader 324 extracts the file data from the backup information. The restoration processor 322 stores the file data extracted by the backup information reader 324 in the primary memory 310 as the file data 312.

In S105, The restoration processor 322 reads the file data 312 from the primary memory 310. The restoration processor 322 instructs the accessor 326 to write the file data 312 to the storage device 600. The accessor 326 writes the file data 312 to the storage device 600.

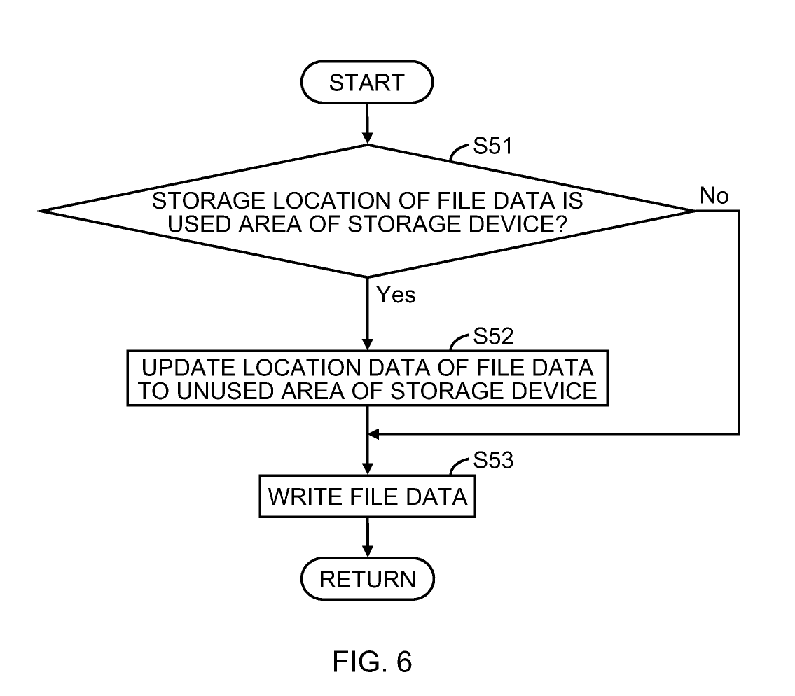

FIG. 6 illustrates an example of a detailed operation flow for writing the file data 312 to the storage device 600 in S105 of FIG. 5.

In S51, the restoration processor 322 compares the second management information table included in the file system management information 311 stored in the primary memory 310 with the usage status data table 313 indicating the usage status of the storage device 600. The restoration processor 322 determines whether the storage location of the file data is a used area or an unused area on the storage device 600. The second management information table includes the location data of the file data, which indicates the storage location of the file data.

In S52, when the storage location of the file data included in the second management information table is a used area on the storage device 600 (“Yes” in S51), the restoration processor 322 changes the storage location of the file data to an unused area on the storage device 600, and stores the location data of the changed storage location of the file data in the second management information table. Change of the storage location of the file data is permitted. Thus, the storage location of the file data may be changed to an unused area on the storage device 600 when the storage location of the file data is a used area on the storage device 600.

When the storage location of the file data included the second management information table is an unused area according to the usage status data table 313 (“No” in S51), the restoration control apparatus 300 advances the process to S53.

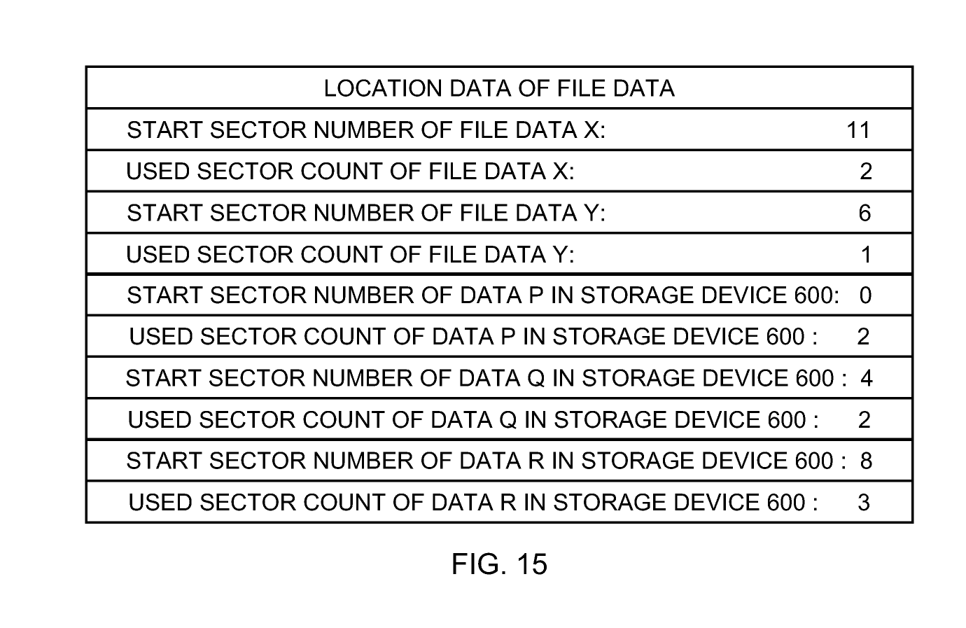

FIG. 15 illustrates an example of the second management information table included in file system management information 311 according to the present embodiment. The example in FIG. 14 illustrates the second management information table after the storage location of the file data has been changed in S52. According to in FIG. 14, the storage location of the file data X is sectors with the sector numbers “4” and “5” which are used areas on the storage device 600. Thus, the storage location of the file data X is changed to sectors with the sector numbers “11” and “12” which are unused areas on the storage device 600. On the other hand, the storage location of the file data Y according to FIG. 14 is a sector with the sector number “6” which is an unused area on the storage device 600. Thus, the storage location of the file data Y is not changed.

In S53 of FIG. 6, the restoration processor 322 instructs the accessor 326 to write the file data 312 stored in the primary memory 310 to the storage device 600 in accordance with the location data of the file data included in the second management information table. The accessor 326 writes the file data 312 to the storage device 600 in accordance with the location data of the file data included in the second management information table.

In S106 of FIG. 5, the restoration processor 322 instructs the accessor 326 to write to the storage device 600 the first management information table and the second management information table included in the file system management information 311. The accessor 326 writes the first management information table and the second management information table to the storage device 600.

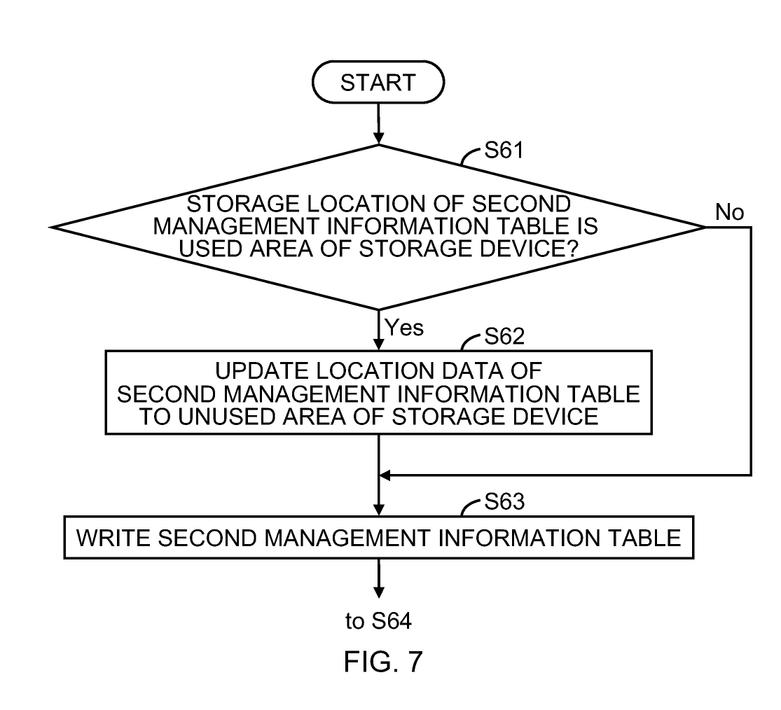

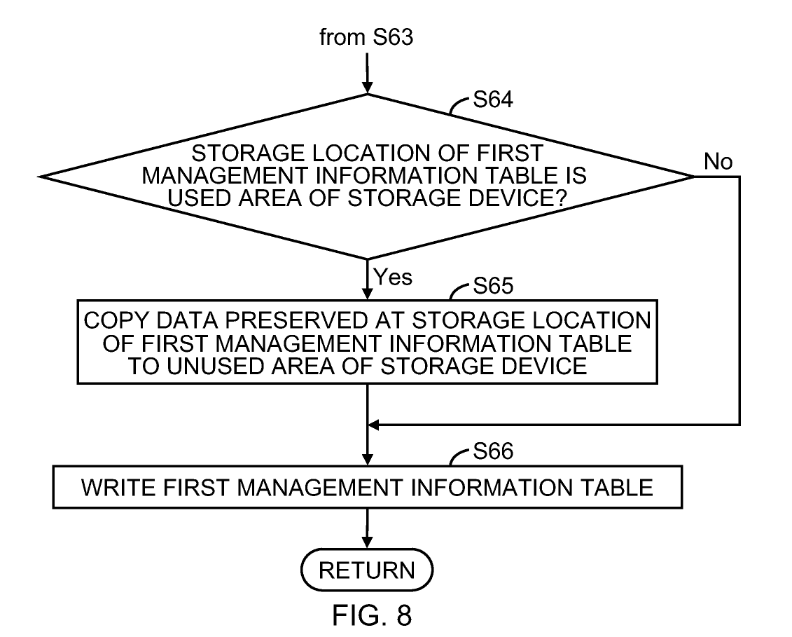

FIGS. 7 and 8 illustrate an example of a detailed operation flow for writing the management information tables in S106 of FIG. 5.

In S61, The restoration processor 322 compares the first management information table included in the file system management information 311 stored in the primary memory 310 with the usage status data table 313 indicating the usage status of the storage device 600. The restoration processor 322 determines whether the storage location of the second management information table is a used area or an unused area on the storage device 600. The first management information table includes the location data of the second management information table, which indicates the storage location of the second management information table.

In S62, when the storage location of the second management information table is a used area on the storage device 600 (“Yes” in S61), the restoration processor 322 changes the storage location of the second management information table to an unused area on the storage device 600 and stores the location data of the changed storage location of the second management information table in the first management information table. Assume that, the storage location of the second management information table is specified as the start sector number is “1” and the used sector count is “1”, for example. Since the sector with the sector number “1” is used on the storage device 600 according to FIG. 12, the restoration processor 322 changes the storage location of the second management information table to an unused area on the storage device 600, i.e., the sector number “14” and a used sector count “1”, and stores the location data of the changed storage location of the second management information table in the first management information table. Change of the storage location of the second management information table is permitted. Thus, the storage location of the second management information table may be changed to an unused area on the storage device 600 when the storage location of the second management information table is a used area on the storage device 600.

When the storage location of the second management information table is an unused area on the storage device 600 (“No” in S61), the restoration control apparatus 300 advances the process to S63.

In S63, the restoration processor 322 instructs the accessor 326 to write the second management information table stored in the primary memory 310 to the storage device 600 in accordance with the location data of the second management information table included in the first management information table. The accessor 326 writes the second management information table to the storage device 600 in accordance with the location data of the second management information table included in the first management information table.

In S64 of FIG. 8, the restoration processor 322 compares the location data of the first management information table included in the file system management information 311 stored in the primary memory 310 with the usage status data table 313 indicating the usage status of the storage device 600. The restoration processor 322 determines whether the storage location of the first management information table is a used area or an unused area on the storage device 600. The location data of the first management information table indicates the storage location of the first management information table.

In the operations discussed above, the restoration control apparatus 300 uses an unused area on the storage device 600 for writing. In other words, no data in the storage device 600 is overwritten. Even if the restoration aborts in an abnormal state in response to a user instruction or an occurrence of any trouble in the operations discussed above, the storage device 600 may be used in the status before the restoration without the need for the restoration control apparatus 300 to perform any process.

In S65, when the storage location of the first management information table is a used area on the storage device 600 (“Yes” in S64), the restoration processor 322 copies, to an unused area on the storage device 600, data to be stored at the storage location of the first management information table in the storage device 600. The restoration processor 322 stores the storage location of the copied data in the second management information table that was written to the storage device 600 in S63. Change of the storage location of the first management information table is inhibited. Thus, the data previously stored at the storage location of the first management information table may be copied to an unused area on the storage device 600 when the storage location of the first management information table is a used area on the storage device 600.

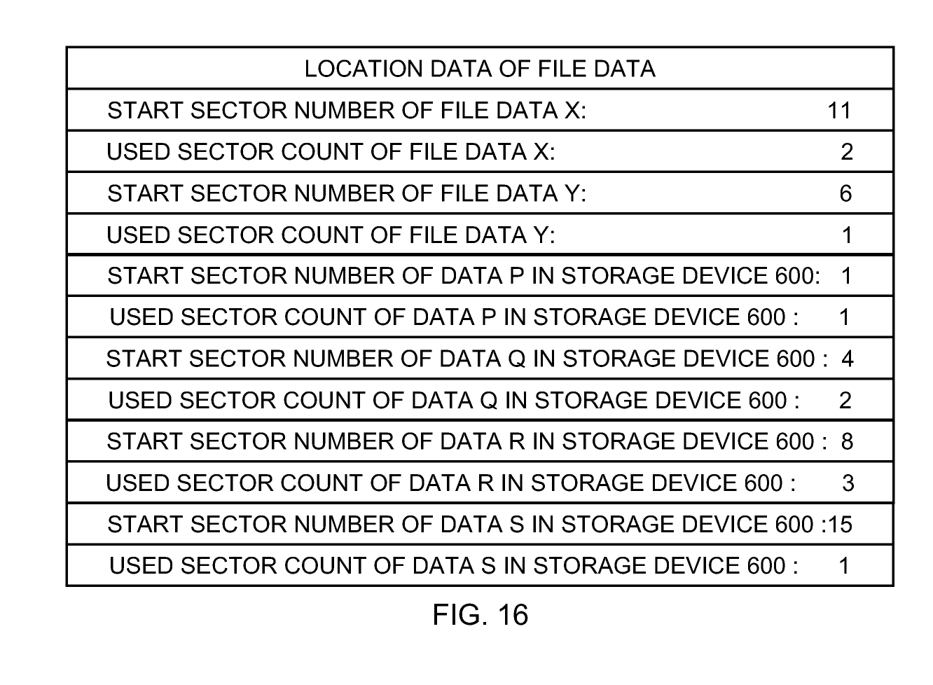

FIG. 16 illustrates an example of the second management information table stored in the storage device 600 according to the present embodiment. The example in FIG. 16 illustrates the second management information table resulting after the location data of the data copied in S65 has been recorded. In the second management information table illustrated in FIG. 16, data S in the storage device 600 is the data copied in S65.

In S65 or subsequent operations, the restoration may be aborted in an abnormal state in response to a user instruction or an occurrence of any trouble. The restoration control apparatus 300 writes the data, which has been copied to an unused area on the storage device 600 in S65, at the storage location of the first management information table on the storage device 600 so that the storage device 600 may be used in the status before the restoration.

When the storage location of the first management information table is an unused area on the storage device 600 (“No” in S64), the restoration control apparatus 300 advances the process to S66.

In S66, the restoration processor 322 instructs the accessor 326 to write the first management information table included in the file system management information 311 stored in the primary memory 310 to the storage device 600 in accordance with the location data of the first management information table. The accessor 326 writes the first management information table to the storage device 600 in accordance with the location data of the first management information table. The restoration control apparatus 300 may terminate the restoration here.

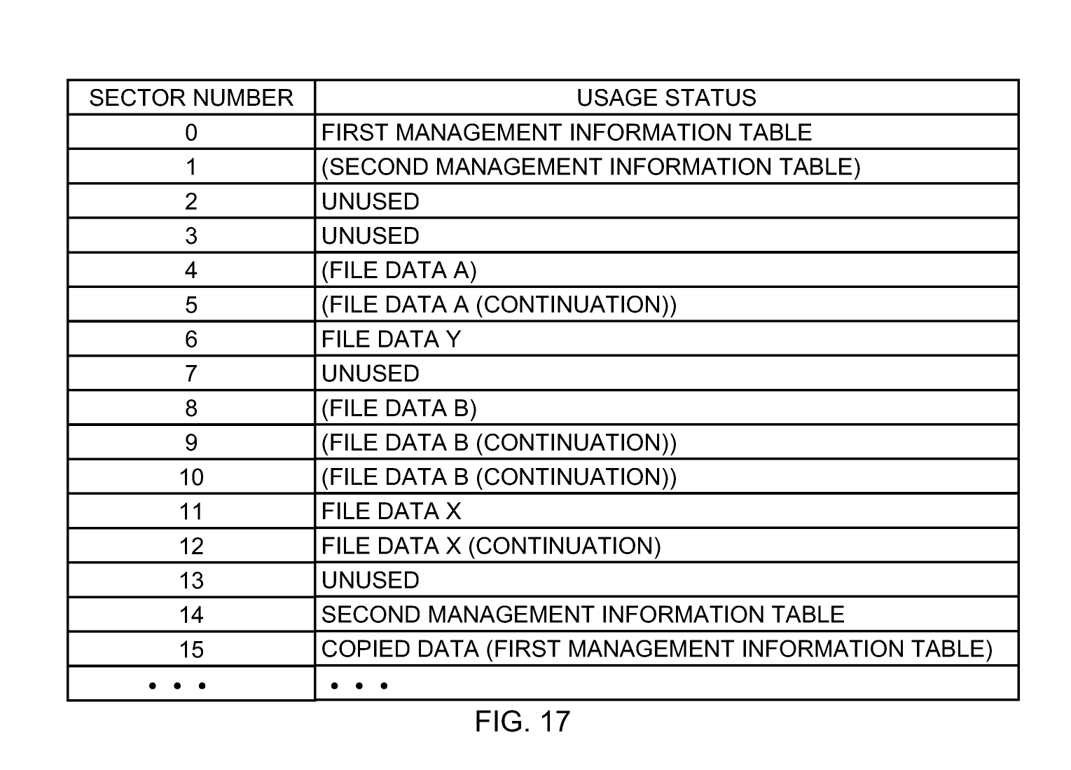

FIG. 17 illustrates an example of the usage status of the storage device 600 after S66. Parenthesized data in FIG. 17 (such as the second management information table of the sector number “1”) is data that has been stored in the storage device 600 before the restoration. Non-parenthesized data in FIG. 17 is data written by the restoration control apparatus 300. If the storage location of the first management information table included in the file system management information 311 is specified as the sector number “0” and a used sector count of “1”, the first management information table is written to the sector with the sector number “0”. The data that has been stored in the sector with the sector number “0” on the storage device 600 before the restoration is copied to the sector with the sector number “15”. The second management information table is written to the sector with the sector number “14”. Since the sectors with the sector numbers “4” and “5” are used areas on the storage device 600, the file data X is written to the sector with the sector numbers “11” and “12”. Since the sector number “6” is an unused area, the file data Y is written to the sector with the sector number “6”. If the restoration is aborted in an abnormal state, the restoration control apparatus 300 may write the data, which has been copied to the sector with the sector number “15”, at the storage location of the first management information table (the sector with the sector number “0”) on the storage device 600. The storage device 600 may thus be used in the status before the restoration.

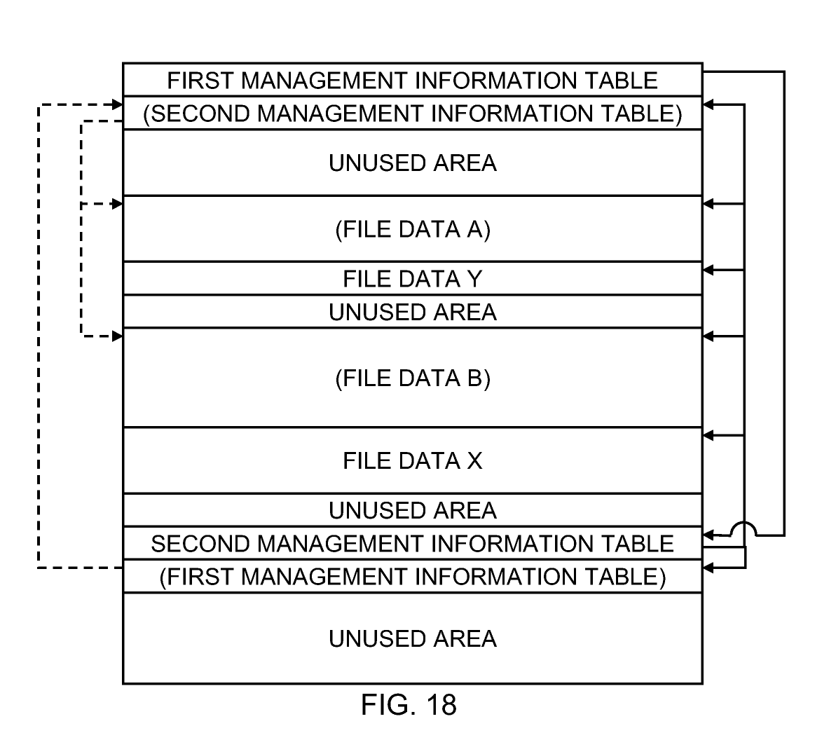

FIG. 18 illustrates an example of the data arrangement of the storage device 600 after S66. Parenthesized data in FIG. 18 is data that has been stored in the storage device 600 before the restoration. Non-parenthesized data in FIG. 18 is data written by the restoration control apparatus 300. The first management information table includes the location data of the second management information table. The second management information table includes the location data of the file data X and the file data Y. The second management information table also includes location data of the data that has been stored in the storage device 600 before the restoration. The first management information table that has been stored in the storage device 600 before the restoration includes the location data of the second management information table that has been stored in the storage device 600 before the restoration. The second management information table that has been stored in the storage device 600 before the restoration includes the location data of the file data A and the file data B that have been stored in the storage device 600 before the restoration.

In S107 of FIG. 5, the restoration processor 322 deletes data stored in or written to the storage device 600 and the restoration control apparatus 300 terminates the restoration in response to a user instruction or the like.

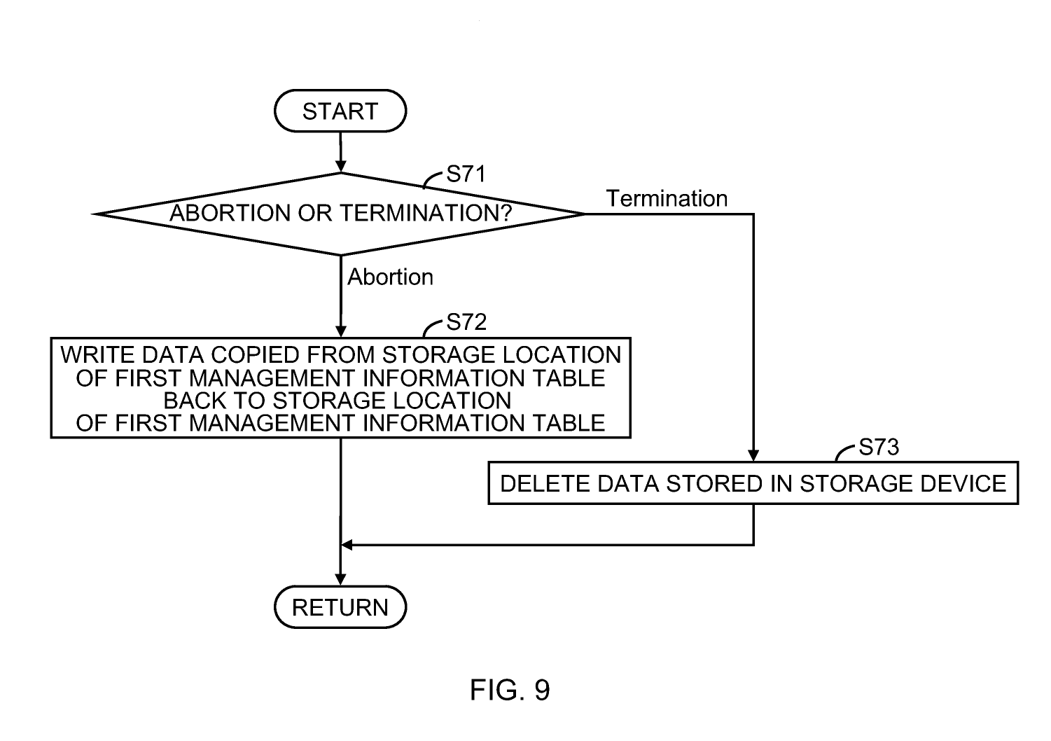

FIG. 9 illustrates an example of an operation flow of terminating restoration in S107 of FIG. 5.

The restoration control apparatus 300 prompts the user to check whether the file data or the like has been correctly written to the storage device 600 and whether the storage device 600 operates normally. The storage location of the data stored in the storage device 600 before the restoration has been stored in the second management information table as a storage location of data stored in the storage device 600 in S103. Thus, the data stored in the storage device 600 before the restoration is not deleted by the behavior check of the storage device 600 by the user.

In S71, the restoration control apparatus 300 allows the user to select between aborting the restoration and terminating the restoration. If the behavior check of the storage device 600 reveals any abnormality, the user may select aborting the restoration. When the abortion of the restoration has been selected, the restoration control apparatus 300 reverts the storage device 600 to the status before the restoration. Alternatively, the accessor 326 of the restoration control apparatus 300 may perform a behavior check and the user may select aborting the restoration when the behavior check reveals an abnormality.

In S72, when the user input device 500 receives an instruction to abort the restoration (“Abortion” in S71), the user input analyzer 325 of the restoration control apparatus 300 notifies the restoration processor 322 of the instruction to abort the restoration. The restoration processor 322 instructs the accessor 326 to write the data copied to the unused area on the storage device 600 in S65 at the storage location of the first management information table on the storage device 600. The storage location of the data that has been copied to the unused area on the storage device 600 in S65 has been stored in the second management information table. The accessor 326 writes the data copied to the unused area on the storage device 600 in S65 at the storage location of the first management information table on the storage device 600. Thus, the data stored in the storage device 600 may be reverted to the status before the restoration. The accessor 326 may delete the data (the backed up data) written to the storage device 600 in the restoration.

In S73, when the user input device 500 receives an instruction to terminate the restoration (“Termination” in S71), the user input analyzer 325 of the restoration control apparatus 300 notifies the restoration processor 322 of the instruction to terminate the restoration. The restoration processor 322 instructs the accessor 326 to delete from the storage device 600 the data stored in the storage device 600. The accessor 326 deletes from the storage device 600 the data stored in the storage device 600. Thus, the status of data arrangement on the backup source storage device may be restored on the storage device 600. Alternatively, the restoration processor 322 may not instruct the accessor 326 to delete the data stored in the storage device 600. The restoration processor 322 may update the second management information table such that the file data stored in the storage device 600 may be used.

The restoration control apparatus 300 thus terminates the restoration.

The backup information reader 324 may directly read the first management information table, the second management information table, and the file data from the storage device illustrated in FIG. 4. The backup information reader 324 may search for the first management information table, starting with the head of the storage device, and then reads the first management information table. The backup information reader 324 acquires as the location data of the first management information table a location data of a location where the first management information table has been read. Since the first management information table is frequently stored at the head of the storage device, the backup information reader 324 may preferably search for the first management information table, starting with the head of the storage device. The backup information reader 324 may search for the first management information table in another method. The backup information reader 324 stores the location data of the first management information table in the primary memory 310 via the file system management information controller 321.

The restoration control apparatus 300 restores the status of data arrangement on the restoration destination storage device in accordance with the backup information. The restoration control apparatus 300 writes the file data at the storage location of the file data on the storage device 600. When the storage location of the file data on the storage device 600 is a used area, the restoration control apparatus 300 writes the file data to another unused area. The restoration control apparatus 300 writes the second management information table at the storage location of the second management information table on the storage device 600. When the storage location of the second management information table on the storage device 600 is a used area, the restoration control apparatus 300 writes the second management information table to another unused area. When the storage location of the first management information table on the storage device 600 is a used area, the restoration control apparatus 300 copies the data stored in that used area to an unused area and then writes the first management information table at the storage location of the first management information table on the storage device 600.

The restoration control apparatus 300 according to the present embodiment writes the file data at the storage location of the file data when the storage location of the file data is an unused area on the storage device 600. Thus, the frequency of change of the storage location of the file data may be reduced. The restoration control apparatus 300 according to the present embodiment writes the second management information table at the storage location of the second management information table when the storage location of the second management information table on the storage device 600 is an unused area. Thus, the frequency of change of the storage location of the second management information table may be reduced.

During the restoration, the restoration control apparatus 300 according to the present embodiment holds the data stored in the storage device 600 before the restoration. Thus, the storage device 600 may be reverted to the status of data arrangement before the restoration even if the restoration is aborted in response to a user instruction or an occurrence of any trouble.

Some or all of the operations discussed above may be implemented as a computer executable code. Such a computer executable code contains a plurality of computer instructions that when performed result in the execution of the tasks discussed herein. Such computer executable code may be available as source code or in object code, and may be further included as part of, for example, a portable memory device or downloaded from the Internet, or embodied on a program storage unit or computer readable medium. Computer executable code may also be available on a computer-readable storage medium which includes all computer-readable media except for a transitory, propagating signal.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been discussed in detail, it should be understood that the various changes, substitutions, and alterations could be made hereto without departing from the spirit and scope of the invention.

What is claimed is:

1. A restoration control apparatus for restoring, in accordance with backup information including backed up data, a status of data arrangement on a destination storage device to a backup state representing a status of data arrangement on a source storage device before the backed up data has been backed up, the restoration control apparatus comprising:
a determiner configured to determine, during restoration, whether a first storage area on the destination storage device preserves prior data, the first storage area being to be restored with the backed up data; and
a controller configured to store, upon determining by the determiner that the first storage area does not preserve prior data, the backed up data in the first storage area, and store, upon determining by the determiner that the first storage area preserves the prior data, the backed up data in an unused second storage area on the destination storage device or copy the prior data preserved in the first storage area to the second storage area to store the backed up data in the first storage area.

2. The restoration control apparatus according to claim 1, wherein
the controller stores the backed up data in the second storage area when the first storage area preserves the prior data and change of a restoration location of the backed up data is permitted.

3. The restoration control apparatus according to claim 2, further comprising:
a memory unit for storing location data of the second storage area, wherein
the controller deletes the backed up data stored in the second storage area in accordance with the location data stored in the memory unit upon receiving during the restoration an instruction for aborting the restoration.

4. The restoration control apparatus according to claim 1, wherein
the controller copies the prior data preserved in the first storage area to the second storage area to store the backed up data in the first storage area when the first storage area preserves the prior data and change of a restoration location of the backed up data is inhibited.

5. The restoration control apparatus according to claim 4, further comprising
a memory unit for storing first location data of the first storage area and second location data of the second storage area, wherein
the controller copies, upon receiving during the restoration an instruction for aborting the restoration, the prior data copied to the second storage area back to the first storage area and deletes the prior data stored in the second storage area in accordance with the first location data and the second location data stored in the memory unit.

6. The restoration control apparatus according to claim 1, further comprising
a memory unit for storing first location data of the first storage area and second location data of the second storage area; and
a behavior checker configured to check behavior of the destination storage device in the backup state by using the backed up data stored in the destination storage device, wherein
the controller reverts the status of data arrangement on the destination storage device to a status before the restoration in accordance with the first location data and the second location data stored in the memory unit when a check result of the behavior of the destination storage device indicates an abnormality.

7. A method executed by a restoration control apparatus for restoring, in accordance with backup information including backed up data, a status of data arrangement on a destination storage device to a backup state representing a status of data arrangement on a source storage device before the backed up data has been backed up, the method comprising:
determining by the restoration control apparatus, during restoration, whether a first storage area on the destination storage device preserves prior data, the first storage area being to be restored with the backed up data;
storing, upon determining that the first storage area does not preserve prior data, the backed up data in the first storage area; and
storing, upon determining that the first storage area preserves the prior data, the backed up data in an unused second storage area on the destination storage device or copying the prior data preserved in the first storage area to the second storage area to store the backed up data in the first storage area.

8. The method according to claim 7, wherein
the restoration control apparatus stores the backed up data in the second storage area when the first storage area preserves the prior data and change of a restoration location of the backed up data is permitted.

9. The method according to claim 8, further comprising:
storing location data of the second storage area in a memory unit; and
deleting the backed up data stored in the second storage area in accordance with the location data stored in the memory unit upon receiving during the restoration an instruction for aborting the restoration.

10. The method according to claim 7, wherein
the restoration control apparatus copies the prior data preserved in the first storage area to the second storage area to store the backed up data in the first storage area when the first storage area preserves the prior data and change of a restoration location of the backed up data is inhibited.

11. The method according to claim 10, further comprising:
storing first location data of the first storage area and second location data of the second storage area in a memory unit; and
copying, upon receiving during the restoration an instruction for aborting the restoration, the prior data copied to the second storage area back to the first storage area and deleting the prior data stored in the second storage area in accordance with the first location data and the second location data stored in the memory unit.

12. The method according to claim 7, further comprising:
storing first location data of the first storage area and second location data of the second storage area in a memory unit;
checking behavior of the destination storage device in the backup state by using the backed up data stored in the destination storage device; and
reverting the status of data arrangement on the destination storage device to a status before the restoration in accordance with the first location data and the second location data stored in the memory unit when a check result of the behavior of the destination storage device indicates an abnormality.

13. A non-transitory computer-readable storage medium storing a program causing a computer for restoring, in accordance with backup information including backed up data, a status of data arrangement on a destination storage device to a backup state representing a status of data arrangement on a source storage device before the backed up data has been backed up to execute:
determining, during restoration, whether a first storage area on the destination storage device preserves prior data, the first storage area being to be restored with the backed up data;
storing, upon determining that the first storage area does not preserve prior data, the backed up data in the first storage area; and
storing, upon determining that the first storage area preserves the prior data, the backed up data in an unused second storage area on the destination storage device or copying the prior data preserved in the first storage area to the second storage area to store the backed up data in the first storage area.

14. The non-transitory computer-readable storage medium according to claim 13, wherein
the program causes the computer to store the backed up data in the second storage area when the first storage area preserves the prior data and change of a restoration location of the backed up data is permitted.

15. The non-transitory computer-readable storage medium according to claim 14, the program further causing the computer to execute:
storing location data of the second storage area in a memory unit; and
deleting the backed up data stored in the second storage area in accordance with the location data stored in the memory unit upon receiving during the restoration an instruction for aborting the restoration.

16. The non-transitory computer-readable storage medium according to claim 13, wherein
the program causes the computer to copy the prior data preserved in the first storage area to the second storage area to store the backed up data in the first storage area when the first storage area preserves the prior data and change of a restoration location of the backed up data is inhibited.

17. The non-transitory computer-readable storage medium according to claim 16, the program further causing the computer to execute:
storing first location data of the first storage area and second location data of the second storage area in a memory unit; and
copying, upon receiving during the restoration an instruction for aborting the restoration, the prior data copied to the second storage area back to the first storage area and deleting the prior data stored in the second storage area in accordance with the first location data and the second location data stored in the memory unit.

18. The non-transitory computer-readable storage medium according to claim 13, the program further causing the computer to execute:
storing first location data of the first storage area and second location data of the second storage area in a memory unit;
checking behavior of the destination storage device in the backup state by using the backed up data stored in the destination storage device; and
reverting the status of data arrangement on the destination storage device to a status before the restoration in accordance with the first location data and the second location data stored in the memory unit when a check result of the behavior of the destination storage device indicates an abnormality.
